(19) United States
(12) Patent Application Publication
(10) Pub. No.: US 2025/0382736 A1
(43) Pub. Date: Dec. 18, 2025

(54) FLUID FILTER FOR AN APPLIANCE INCORPORATING A DYNAMIC BYPASS MECHANISM

(71) Applicant: WHIRLPOOL CORPORATION, BENTON HARBOR, MI (US)

(72) Inventors: Omar Rachid Murad, Rio Claro (BR); Bruno Torquato-Ramasco, Stevensville, MI (US); Tibor Budicky, Mlynica (SK)

(73) Assignee: WHIRLPOOL CORPORATION, BENTON HARBOR, MI (US)

(21) Appl. No.: 18/747,020

(22) Filed: Jun. 18, 2024

(51) Int. Cl. D06F 39/10; B01D 41/00; D06F 39/08

(52) U.S. Cl. CPC D06F 39/10; B01D 41/00; D06F 39/085; B01D 2201/086

(57) ABSTRACT

An appliance includes a filter housing having a filter chamber between a fluid inlet and outlet. A fluid filter is within the filter chamber and has a base and a particulate collector attached via a biasing mechanism that biases the particulate collector toward a filtering position. Operation of a fluid pump directs fluid from the fluid inlet and through a filter media of the particulate collector that biases the particulate collector away from the filtering position. The filter media separates particulate matter from the fluid. When the filter media is impacted by an amount of the captured particulate, the fluid creates a pressure differential that overcomes the biasing mechanism and biases the particulate collector to a bypass position that directs the fluid around an outside surface of the particulate collector and to the fluid outlet.

### BACKGROUND OF THE DISCLOSURE

The present disclosure generally relates to laundry appliances and, more specifically, to a fluid filter for a laundry appliance that is used for separating microparticles from process fluid.

### SUMMARY OF THE DISCLOSURE

According to one aspect of the present disclosure, a an appliance including a fluid delivery system having a filter housing that defines a filter chamber disposed between a fluid inlet and a fluid outlet, a fluid filter selectively disposed within the filter chamber, the fluid filter having a base and a particulate collector attached to the base via a biasing mechanism that biases the particulate collector toward a filtering position, and a fluid pump that directs fluid through the filter chamber via the fluid inlet, wherein operation of the fluid pump in the filtering position of the particulate collector directs the fluid from the fluid inlet and through a filter media of the particulate collector that biases the particulate collector away from the filtering position, wherein the filter media separates particulate matter from the fluid to define captured particulate within the filter media, and wherein when the filter media is impacted by an amount of the captured particulate, movement of the fluid through the particulate collector creates a pressure differential that overcomes the biasing mechanism and biases the particulate collector to a bypass position that directs at least a portion of the fluid around an outside surface of the particulate collector and to the fluid outlet.

According to another aspect of the present disclosure, a filter module for an appliance includes a filter housing defining a filter chamber, a fluid pump incorporated with the filter housing and configured to direct a fluid toward a fluid outlet of the filter housing, a fluid filter selectively disposed within the filter chamber and having a base and a particulate collector, wherein the particulate collector separates particulate matter from the fluid to define captured particulate within a filter media of the particulate collector, and a bypass mechanism that is operable between a filtering position and a bypass position, wherein the bypass mechanism is continuously biased toward the filtering position that directs the fluid through a filter media of the particulate collector and to the fluid outlet to define a filtered fluid, and wherein the bypass mechanism is selectively biased to the bypass position when the filter media is impacted by an amount of the captured particulate, wherein the bypass position is characterized by the fluid pump directing at least a portion of the fluid through a bypass path that extends around the particulate collector to the fluid outlet to define an unfiltered fluid.

According to yet another aspect of the present disclosure, a filter module for an appliance includes a filter housing having an impeller chamber and a filter chamber that are connected by a fluid inlet, a fluid filter within the filter chamber that separates particulate matter from a fluid to define captured particulate, the fluid filter operable between a filtering position and a bypass position, a biasing mechanism that biases the fluid filter toward the filtering position, and a fluid pump that directs the fluid from the impeller chamber and through the fluid filter in the filtering position and defines a pressure differential that biases the fluid filter toward the bypass position, wherein when an accumulation of the captured particulate is defined on an inner surface of the fluid filter, the pressure differential overcomes the biasing mechanism and operates the fluid filter to the bypass position that directs at least a portion of the fluid through a bypass path that extend from the fluid inlet, around an outer surface of the fluid filter, and to an outlet of the fluid housing.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevational view of a laundry appliance that incorporates an aspect of the filter module;

FIG. 2 is an enlarged perspective view of an aspect of the filter module with the fluid filter separated therefrom;

FIG. 3 is a schematic diagram illustrating a flow of process fluid through the filter module of FIG. 2;

FIG. 4 is a cross-sectional view of the filter module of FIG. 3 taken along line IV-IV and shown with the fluid filter installed and the fluid pump removed from a filter housing of the filter module;

FIG. 5 is a schematic cross-section diagram illustrating flow of process fluid through the filter module in a filtering position;

FIG. 6 is an enlarged view of the filter module of FIG. 4 and showing movement of process fluid through the filter module in a bypass position;

FIG. 7 is a schematic diagram illustrating an aspect of the device with a fluid pump positioned downstream of the filter chamber and fluid filter;

FIG. 8 is a schematic diagram illustrating an aspect of the filter module and showing movement of the process fluid through the filter module in a filtering position;

FIG. 9 is a schematic diagram of the filter module of FIG. 8 and showing movement of the fluid in a bypass position;

FIG. 10 is a schematic diagram illustrating an aspect of the filter module that includes a regeneration pump for extending the use of the fluid filter;

FIG. 11 is a schematic diagram illustrating an aspect of the filter module that includes the regeneration pump;

FIG. 12 is a linear flow diagram illustrating a method for operating a filter module for an appliance; and

FIG. 13 is a method for operating a filter module for an appliance.

The components in the figures are not necessarily to scale, emphasis instead being placed upon illustrating the principles described herein.

### DETAILED DESCRIPTION

The present illustrated embodiments reside primarily in combinations of method steps and apparatus components related to a filter module that includes a fluid filter for separating particulate from a process fluid, and where the filter module includes a dynamic bypass mechanism that allows for the movement of process fluid when the fluid filter is impacted by captured particulate. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

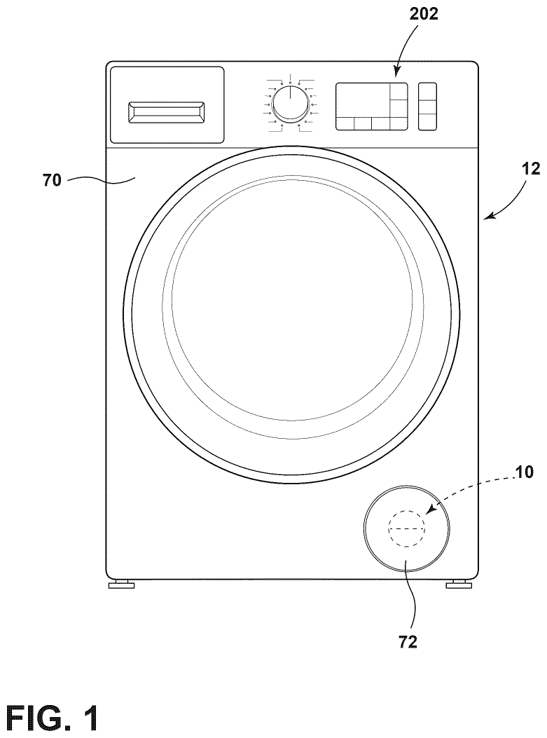

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

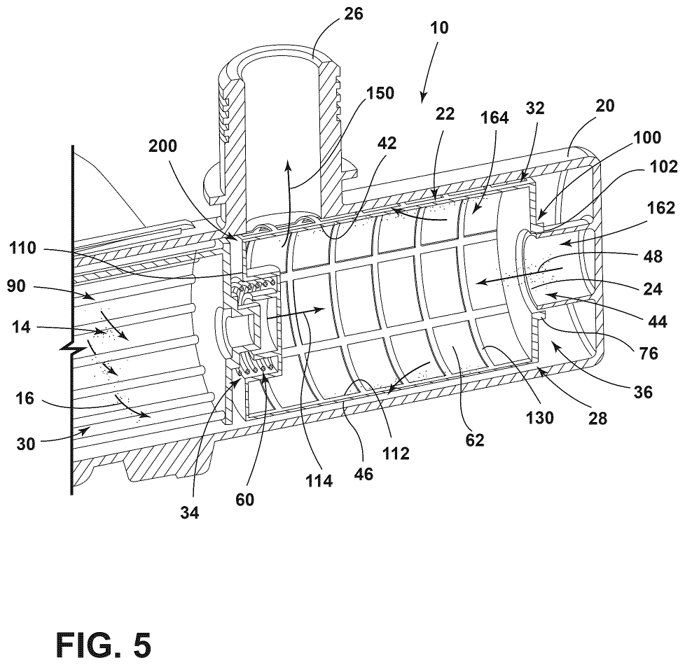

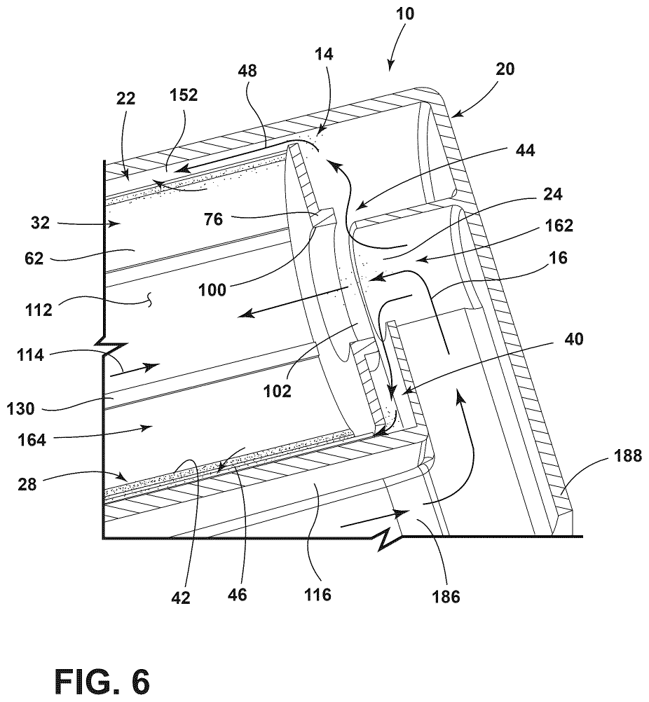

Referring to FIGS. 1-6, reference numeral 10 generally refers to a filter module 10 that is incorporated within an appliance 12 for separating particulate 14 from process fluid 16 moved through the appliance. According to the various aspects of the device, the appliance 12 includes a fluid delivery system 18 that includes the filter module 10. The filter module 10 includes a filter housing 20 that defines a filter chamber 22 disposed between a fluid inlet 24 and a fluid outlet 26. A fluid filter 28 is selectively disposed within the filter chamber 22. The fluid filter 28 includes a base 30 and a particulate collector 32. The base 30 and the particulate collector 32 can be attached to one another via a biasing mechanism 34. The biasing mechanism 34 biases the particulate collector 32 toward a filtering position 36 within the filter chamber 22. A fluid pump 38 directs fluid, typically process fluid 16, through the filter chamber 22 via the fluid inlet 24. Operation of the fluid pump 38 in the filtering position 36 of the particulate collector 32 directs the process fluid 16 from the fluid inlet 24 and through the particulate collector 32. This movement of the process fluid 16 through the particulate collector 32 tends to bias the particulate collector 32 away from the filtering position 36 and toward a bypass position. The particulate collector 32 separates particulate 14 matter, typically microparticles, from the process fluid 16 to define captured particulate 42 within the particulate collector 32. When the particulate collector 32 is impacted by an amount of the captured particulate 42, movement of the process fluid 16 through the filter chamber 22 creates a pressure differential 44 that can overcome the biasing mechanism 34. This pressure differential 44, when the particulate collector 32 is impacted, operates to bias the particulate collector 32 toward the bypass position. In this bypass position, the fluid pump 38 directs at least a portion of the process fluid 16 around an outside surface 46 of the particulate collector 32 and into the fluid inlet 24. In this manner, in the bypass position, a portion of the process fluid 16 is not filtered within the particulate collector 32 and proceeds as unfiltered fluid 48 to the fluid outlet 26.

According to the various aspects of the device, the filter module 10 utilizes this pressure differential 44 to create a dynamic bypass mechanism 60. In certain aspects of the device, this bypass mechanism 60 includes the biasing mechanism 34 of the particulate collector 32 that moves the particulate collector 32 to the bypass position 40 when the particulate collector 32 is impacted by a certain amount of captured particulate 42. As described herein, the bypass mechanism 60 can take the form of various mechanisms that allow for the movement of unfiltered fluid 48 to move from the fluid inlet 24 and to the fluid outlet 26, and bypassing the particulate collector 32. As described herein, the bypass mechanism 60 operates when the particulate collector 32 is impacted with the captured particulate 42. Typically, the particulate collector 32 includes a mesh screen or other filter media 62 that is disposed within the particulate collector 32. This filter media 62 operates to separate the particulate 14 from a process fluid 16 to define captured particulate 42 within the particulate collector 32 and filtered fluid 150 that is directed through the fluid outlet 26 of the filter module 10.

Referring again to FIGS. 1-6, the appliance 12, typically a laundry appliance, includes the filter module 10. An outer cabinet 70 of the appliance 12 includes an access panel 72 that can be removed for accessing the filter module 10. Typically, the access panel 72 is removed for accessing the fluid filter 28. This fluid filter 28 can be selectively removed from the filter chamber 22 of the filter module 10. The base 30 of the fluid filter 28 includes an attachment mechanism 74 that secures the fluid filter 28 to the filter housing 20 of the filter module 10. Typically, a threaded interface is defined between the base 30 and the filter housing 20 to secure the fluid filter 28 within the housing. In this position, the particulate collector 32 is disposed in the filtering position 36 such that a first end 76 of the particulate collector 32 is seated against the filter housing 20 such that the first end 76 of the particulate collector 32 surrounds the fluid inlet 24. In this configuration, process fluid 16 entering into the filter chamber 22 through the fluid inlet 24 is entirely directed through the filter media 62 of the particulate collector 32, then toward the fluid outlet 26. It is contemplated that the base 30 of the fluid filter 28 can include different attachment mechanisms that can be used to secure the fluid filter 28 within the filter chamber 22 of the filter housing 20. Such attachment mechanisms can include but are not limited to, tabs, clasps, push-push mechanisms, fasteners, mating assemblies, friction assemblies, and other similar interference mechanisms.

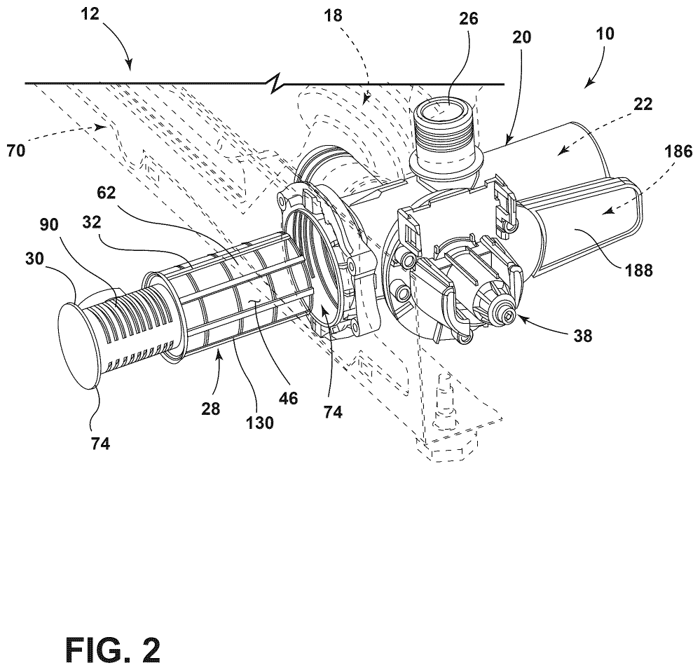

Referring again to FIGS. 2-5, it is contemplated that the fluid filter 28 can include an upstream filter 90 that is utilized for capturing larger particulates, such as large lint, dirt particles, and objects that may be present within the process fluid 16. After this first stage of filtration, the process fluid 16 is directed by the fluid pump 38 toward the filter chamber 22 to be passed through the filter media 62 of the particulate collector 32. As described herein, the particulate collector 32 may operate relative to the base 30 between the filtering position 36 and the bypass position 40. In certain aspects of the device, the base 30 includes the upstream filter 90 that maintains a static position within the filter chamber 22. It is also contemplated that the upstream filter 90 may operate with the particulate collector 32 between the filtering position 36 and the bypass position 40. In each of these positions, it is contemplated that the upstream filter 90 maintains a position relative to a fluid path for capturing larger particulates from the process fluid 16.

Referring again to FIGS. 2-6, the particulate collector 32 includes a seat 100 at the first end 76 of the particulate collector 32. This seat 100 engages the filter housing 20 proximate the fluid inlet 24 in the filtering position 36. As described herein, this engagement between the seat 100 at the first end 76 of the particulate collector 32 and the filter housing 20 proximate the fluid inlet 24 directs the process fluid 16 through the filter media 62 of the particulate collector 32. The seat 100 can include a seal 102 that seals the particulate collector 32 around the fluid inlet 24 in the filtering position 36. This seal 102 prevents the process fluid 16 from moving around the outer surface of the particulate collector 32 until such time as the particulate collector 32 is moved to the bypass position 40 as described herein.

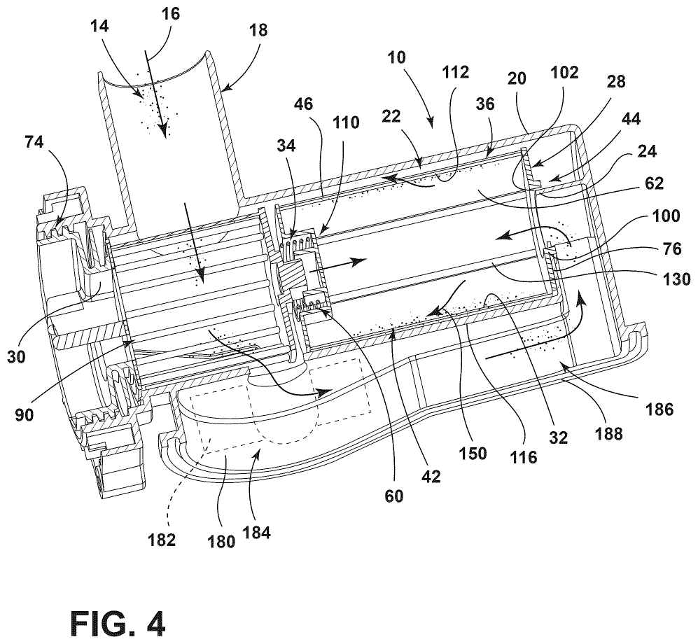

Referring again to FIGS. 4-6, the biasing mechanism 34 can be disposed at a second end 110 of the particulate collector 32 that opposes the first end 76. During operation of the filter module 10, captured particulate 42 collects on an interior surface 112 of the filter media 62. As the filter media 62 becomes progressively impacted with greater amounts of the captured particulate 42, less of the process fluid 16 is able to pass through the filter media 62 and toward the fluid outlet 26. This configuration creates the pressure differential 44 between an area within the particulate collector 32 and an area surrounding the particulate collector 32. More particularly, as less fluid is able to move through the filter media 62, a low-pressure area 164 is defined within the particulate collector 32, and contemporaneously, a higher-pressure area forms around the particulate collector 32, particularly at the fluid inlet 24 of the housing and the seat 100 of the particulate collector 32. This pressure differential 44 overcomes the biasing force 114 of the biasing mechanism 34 and progressively biases the particulate collector 32 away from the filtering position 36 and toward the bypass position 40. Once in the bypass position 40, at least a portion of the process fluid 16 is able to move between the seat 100 and an interior wall 116 of the filter housing 20 that defines the fluid inlet 24.

Referring again to FIGS. 4-6, the particulate collector 32 can include a frame 130 that receives the filter media 62. The filter media 62 can be adhered, attached, or otherwise disposed on the frame 130 for securing the filter media 62 to the fluid filter 28. When the fluid filter 28 needs to be replaced, as described herein, it is contemplated that the entire fluid filter 28 can be reused, recycled, or otherwise disposed of. It is also contemplated that the particulate collector 32 can be separately removed from the base 30 for disposal, as described herein. Also, it is contemplated that the filter media 62 can be separated from the particulate collector 32 to be recycled or otherwise disposed of.

It is contemplated that the use of the filter module 10 is intended to capture microparticles, in particular microfibers, that are present within the process fluid 16. These microfibers can be captured by the filter module 10 and prevented from leaving the appliance 12 and being delivered back into the municipal wastewater system, septic system, or other wastewater system.

Additionally, it is contemplated that the filter module 10 described herein can be installed within any one of the various appliances 12 that utilize fluid from a municipal water supply, well, reservoir, or other similar external water source. These appliances 12 can include, but are not limited to, washing appliances, drying appliances, combination washing and drying appliances, dishwashers, refrigerators, ovens, icemaking appliances, and other similar appliances 12 that utilize water from an external source.

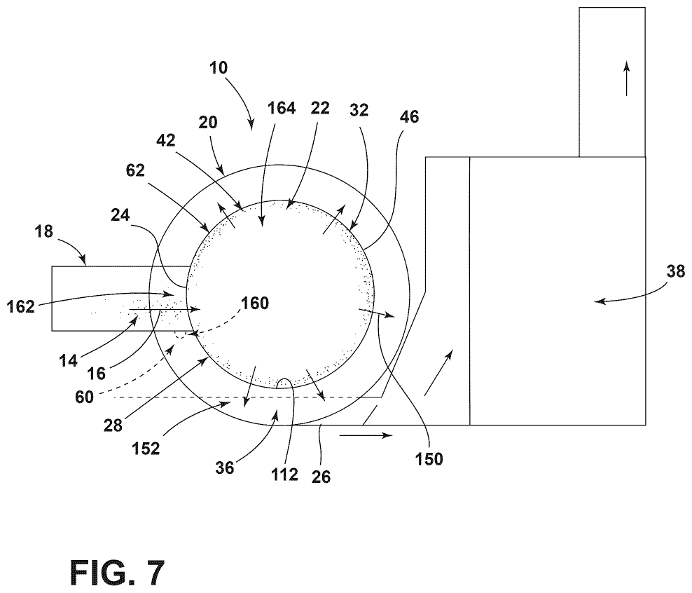

Referring to FIGS. 1-9, the filter module 10 includes the filter housing 20 that defines the filter chamber 22. The fluid pump 38 is incorporated within the filter housing 20 and is configured to direct the process fluid 16 toward the fluid outlet 26 of the filter housing 20. The fluid filter 28 is selectively disposed within the filter chamber 22 and includes the base 30 and the particulate collector 32. The particulate collector 32 separates particulate 14 from process fluid 16 to define captured particulate 42 within the filter media 62 of the particulate collector 32. The bypass mechanism 60 is operable between the filtering position 36 and the bypass position 40. The bypass mechanism 60 is continuously biased toward the filtering position 36 that directs the process fluid 16 through the filter media 62 of the particulate collector 32 and to the fluid outlet 26. After passing through the filter media 62, the process fluid 16 defines a filtered fluid 150 that is directed to the fluid outlet 26. The bypass mechanism 60 is selectively biased to the bypass position 40 when the filter media 62 is impacted by an amount of the captured particulate 42. The bypass position 40 is characterized by the fluid pump 38 directing at least a portion of the process fluid 16 through a bypass path 152 that extends around the particulate collector 32 to the fluid outlet 26 to define an unfiltered fluid 48. As described herein, in the bypass position 40, a certain amount of the process fluid 16 may still be filtered by the filter media 62. Additionally, the bypass mechanism 60 can be progressively operable from the filtering position 36 to the bypass position 40 as the filter media 62 progressively collects additional amounts of captured particulate 42.

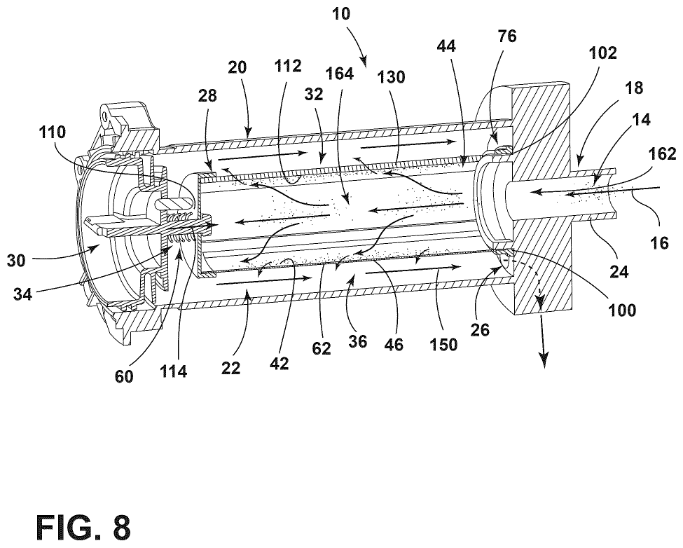

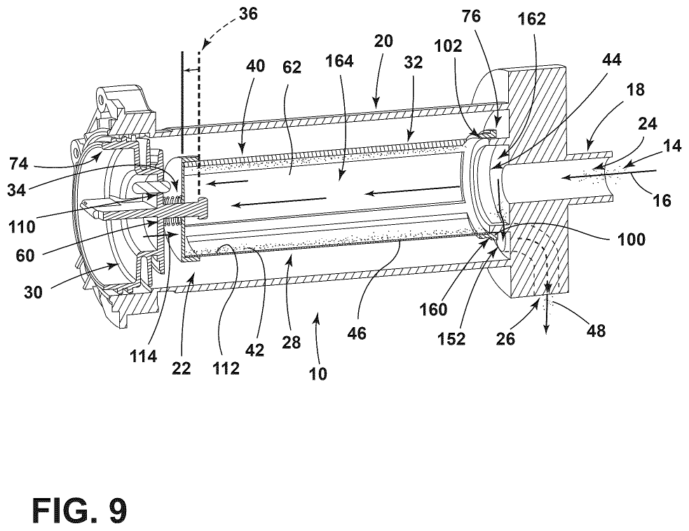

As exemplified in FIGS. 8 and 9, the bypass mechanism 60 can include a bypass valve 160 that moves from the filtering position 36 toward the bypass position 40 as the filter media 62 progressively collects the captured particulate 42. As described herein, the pressure differential 44 between the area within the particulate collector 32 and the area proximate the fluid inlet 24 and the bypass valve 160 changes as the particulate 14 collects on the inner surface of the filter media 62. When this pressure differential 44 reaches a certain magnitude, the high-pressure area 162 proximate the bypass valve 160, combined with the low-pressure area 164 within the particulate collector 32, causes the bypass valve 160 to open toward the bypass position 40. This operation of the bypass valve 160 can be dynamic and progressive as the filter media 62 becomes more impacted by the captured particulate 42. Alternatively, the bypass valve 160, or other aspect of the bypass mechanism 60 can move from the filtering position 36 to the bypass position 40 upon the pressure differential 44 reaching a certain magnitude. In such an aspect of the device, the bypass mechanism 60 can be calibrated to move when the filter media 62 is impacted to a certain degree by the captured particulate 42. As described herein, when the bypass mechanism 60 moves toward the bypass position 40, a certain amount of unfiltered fluid 48 is directed to the fluid outlet 26 without being filtered by the filter media 62. As exemplified in FIGS. 8 and 9, it is contemplated that the bypass valve 160 can be disposed within the interior wall 116 to proximate the fluid inlet 24.

As exemplified in FIGS. 4-6, the bypass mechanism 60 can also take the form of a biasing mechanism 34 that is disposed on the fluid filter 28. In this aspect of the device, the particulate collector 32 moves from the filtering position 36 to the bypass position 40 as particulate 14 collects on the inner surface of the filter media 62.

Referring now to FIGS. 2-7, the filter housing 20 can include a volute 180 that houses an impeller 182 of the fluid pump 38. This volute 180 is positioned in fluid communication with the filter chamber 22, and can be positioned upstream or downstream of the filter chamber 22. During operation of the fluid pump 38, the impeller 182 rotates within the impeller chamber 184 of the volute 180 to move process fluid 16 through the upstream filter 90 of the fluid filter 28. The process fluid 16 is then moved from the volute 180 and toward the fluid inlet 24. A flow channel 186 can extend between the volute 180 and the fluid inlet 24 to direct the process fluid 16 into the filter chamber 22.

As exemplified in FIGS. 4-6, the volute 180 is positioned upstream of the filter chamber 22 and the volute 180 is incorporated within a portion of the filter housing 20. In this aspect of the device, the filter chamber 22 and the volute 180 are separated by the interior wall 116 of the housing. It is contemplated that the fluid inlet 24 can be defined within this interior wall 116. Accordingly, the volute 180 and the flow channel 186 are defined between the interior wall 116 and an outer wall 188 of the housing. This configuration provides for a dual filtering configuration of the filter module 10 that includes the upstream filter 90 and the filter media 62 defined within the filter chamber 22.

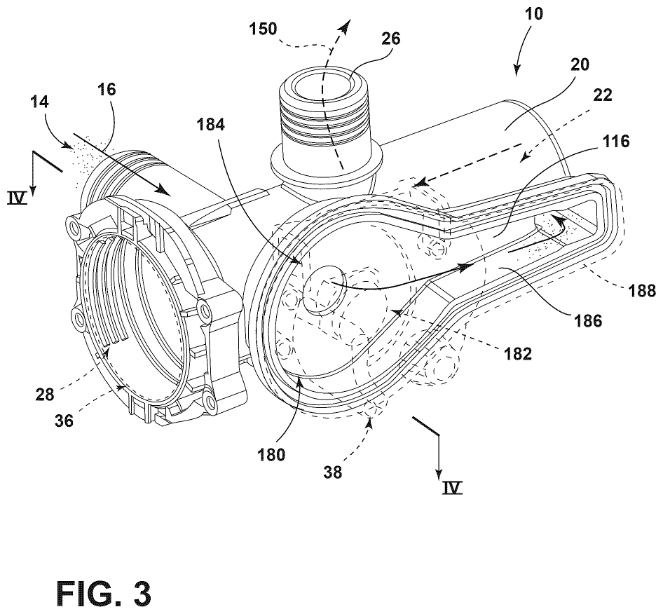

As exemplified in FIGS. 3-9, the bypass path 152 that is defined in the bypass position 40 of the filter module 10 delivers the unfiltered fluid 48 from the fluid inlet 24 and around the particulate collector 32. In this manner, the unfiltered fluid 48 does not pass through the filter media 62 but extends around the particulate collector 32 to be directed to the fluid outlet 26. This bypass path 152 can be in the form of an area of the filter chamber 22 around the outer surface of the particulate collector 32. This bypass path 152 can also be a separate channel that is defined within the housing and that extends between the fluid inlet 24 to the fluid outlet 26 or from the flow channel 186 of the filter housing 20 into the fluid outlet 26. In each of these configurations, a portion of the process fluid 16 is delivered outside of the filter media 62 and to the fluid outlet 26 as unfiltered fluid 48.

According to the various aspects of the device, when the bypass mechanism 60 is moved to the bypass position 40, various sensors or other sensing mechanisms can be utilized to provide a signal to a controller 202 (shown in FIG. 1) of the appliance 12 that the fluid filter 28 needs to be replaced, cleaned, or otherwise maintained. It is contemplated that a sensor 200 can monitor the movement of the particulate collector 32 with respect to the fluid inlet 24. Where the bypass mechanism 60 is the bypass valve 160, motion of the bypass valve 160 can also be monitored. When in the bypass position 40, the controller 202 can receive a signal indicative of the fluid filter 28 needing to be replaced. This information can be communicated to the user of the appliance 12 through a user interface, a portable computer device, or other similar communication that can be directed to the user. The sensor 200 can also measure a quality of the process fluid 16, such as the fluid velocity, fluid pressure, or other similar quality of the process fluid 16.

It is contemplated that, when the fluid filter 28 moves to the bypass position 40, limiting the amount of unfiltered fluid 48 that is delivered to the fluid outlet 26 can be kept to a minimum. Accordingly, operation of the appliance 12 may change when the fluid filter 28 is moved to the bypass position 40. It is also contemplated that a subsequent cycle of the appliance 12 may be modified until such time as the fluid filter 28 is maintained through cleaning or replacement. Such limitations in operation can be in the form of auditory signals, slowed or otherwise modified performance, repeated communications to the user, and other similar modifications in performance of the appliance 12. In certain conditions, the modification in performance may be a deactivation of the appliance 12.

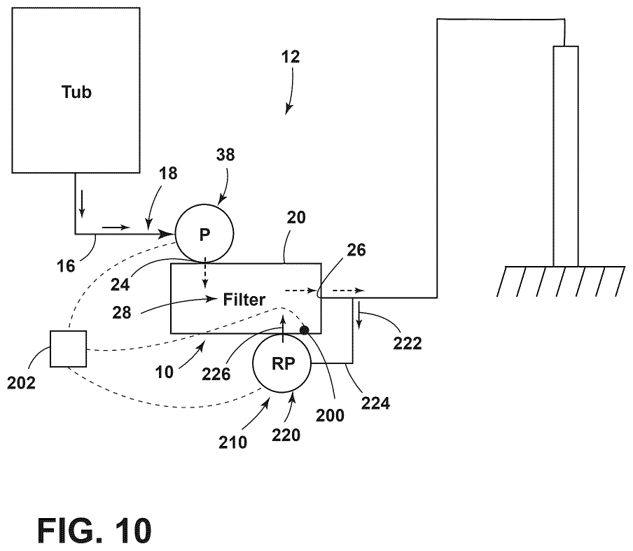

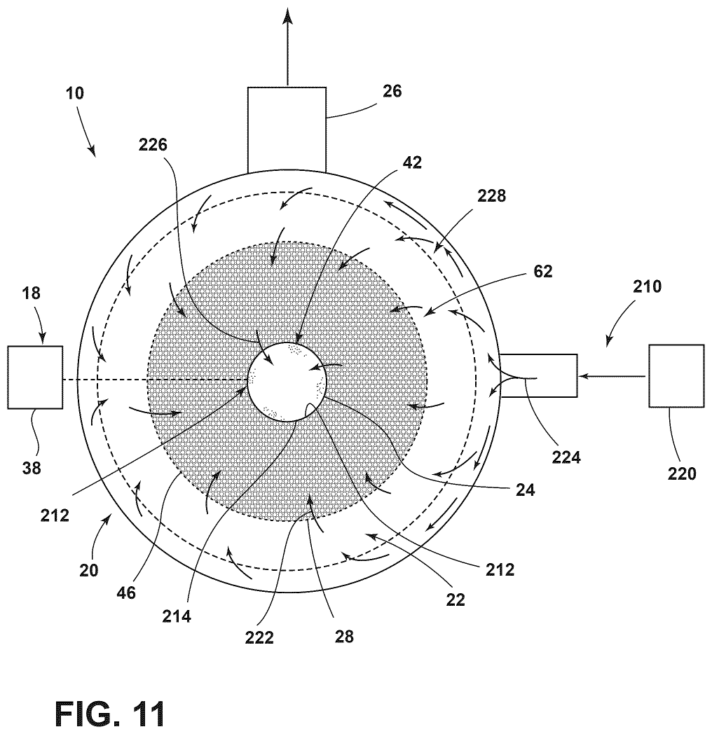

Referring now to FIGS. 10 and 11, the filter module 10 can include a regeneration mechanism 210 that selectively operates to redistribute the captured particulate 42 within the particulate collector 32. This redistribution of the captured particulate 42 can operate to reaccumulate the captured particulate 42 on at least one concentrated portion 212 of the filter media 62 or a plurality of concentrated portions on the filter media 62. The cleaned portions 214 of the filter media 62 can be defined between or around the various concentrated portions of the particulate 14 on the inner surface of the filter media 62. When the regeneration mechanism 210 is operated, portions of the filter media 62 are cleaned of the captured particulate 42, while maintaining the captured particulate 42 within the particulate collector 32. The regeneration mechanism 210 cleaning the filter media 62 allows the process fluid 16 to be moved through the cleaned portions 214 of the particulate collector 32 and through the filter media 62 to proceed to the fluid outlet 26. Stated another way, the regeneration mechanism 210 operates to diminish or eliminate the pressure differential 44 present between the area within the particulate collector 32 and the area surrounding the particulate collector 32. By eliminating or diminishing this pressure differential 44, the biasing force 114 of the biasing mechanism 34 is able to move the particulate collector 32 back to the filtering position 36. Where the bypass valve 160 is implemented, use of the regeneration mechanism 210 operates to eliminate the pressure differential 44 to return the bypass valve 160 to the filtering position 36.

In certain aspects of the device, as exemplified in FIGS. 10 and 11, the regeneration mechanism 210 can be in the form of a regeneration pump 220. This regeneration pump 220 can operate to direct an opposing flow 222 of a regeneration fluid 224 from an area outside the filter media 62, through the filter media 62, and into an inside of a particulate collector 32 via the filter media 62. Accordingly, the regeneration pump 220 can draw filtered fluid 150, or at least partially filtered fluid 150, from an area downstream of the filter housing. This regeneration fluid 224 is directed into the filter chamber 22 and through the filter media 62 in an opposing direction 226 that pushes the captured particulate 42 away from the interior surface 112 of the filter media 62. Accordingly, the regeneration fluid 224 pushes the captured particulate 42 away from the inner surface of the filter media 62 to be redistributed within this interior area of the filter chamber 22. In order to evenly distribute the regeneration fluid 224 along the outside surface 46 of the filter media 62 and through the filter media 62 in a generally evenly distributed opposing flow 222 of the regeneration fluid 224, the filter chamber 22 can include a spreader 228. This spreader 228 is disposed between the filter media 62 and the outer wall 188 of the of the filter housing 20 and distributes the regeneration fluid 224 around the filter media 62. In this manner, the regeneration fluid 224 is able to pass through different areas of the filter media 62 in the opposing direction 226.

It is contemplated that, when the regeneration pump 220 is activated, the fluid pump 38 of the filter module 10 is temporarily deactivated so as to not counteract the operation of the regeneration pump 220. Once the regeneration pump 220 completes its cycle, the regeneration pump 220 is deactivated, and the fluid pump 38 is reactivated. This reactivation of the fluid pump 38 moves process fluid 16 into the filter chamber 22 and directs the particulate 14 within the filter chamber 22 toward the filter media 62 in the reaccumulated state on the concentrated portions of the inner surface of the filter media 62.

According to the various aspects of the device, the regeneration pump 220 may be activated successively to extend the usable life of the filter media 62 of the fluid filter 28. When the regeneration pump 220 is no longer effective at redistributing the accumulated particulate 14, the signal for replacing the filter can be activated, as described herein. The regeneration pump 220 may be reactivated to perform successive cycles until such time as the reaccumulation of the particulate 14 on the inner surface of the filter media 62 no longer clears enough surface to eliminate the pressure differential 44. When this pressure differential 44 cannot be eliminated or diminished to a sufficient extent, the particulate collector 32 tends to remain in the bypass position 40, or moves back to the bypass position 40 after a short period of time.

Referring now to FIGS. 1-11, the filter module 10 for the appliance 12 includes the filter housing 20 having the filter chamber 22 and the impeller chamber 184 defined therein. The filter chamber 22 and the impeller chamber 184 are connected by the fluid inlet 24. The fluid filter 28 is selectively disposed within the filter chamber 22 and separates particulate 14 from the process fluid 16 to define captured particulate 42 on the filter media 62. The fluid filter 28 is operable between the filtering position 36 and the bypass position 40. The bypass mechanism 60 operates to bias the fluid filter 28 to the filtering position 36. The fluid pump 38 operates an impeller 182 within the impeller chamber 184 and directs the process fluid 16 through the fluid filter 28 in the filtering position 36 and defines a pressure differential 44 that biases the fluid filter 28 toward the bypass position 40. When an accumulation of the captured particulate 42 is defined on an inner surface of the fluid filter 28, the pressure differential 44 overcomes the biasing mechanism 34 and operates the fluid filter 28 to the bypass position 40. In the bypass position 40, the fluid pump 38 directs at least a portion of the process fluid 16 through the bypass path 152 that extends from the fluid inlet 24, around an outer surface of the fluid filter 28, and to the fluid outlet 26 of the fluid housing.

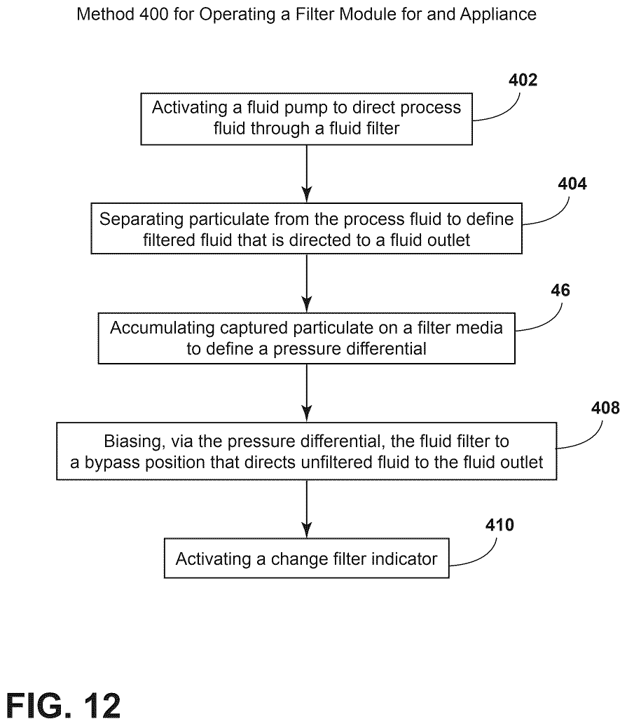

Referring now to FIGS. 1-12, having described the various aspects of the filter module 10, a method 400 is disclosed for operating a filter module 10. According to the method 400, the fluid pump 38 is activated to direct process fluid 16 through the fluid filter 28 in the filtering position 36 (step 402). Particulate 14 is separated from the process fluid 16 to define filtered fluid 150 that is directed to a fluid outlet 26 (step 404). In the filtering position 36, captured particulate 42 is accumulated on the filter media 62 of the fluid filter 28 (step 406). As the captured particulate 42 accumulates on the filter media 62, the fluid filter 28 is biased to the bypass position 40 when an amount of the captured particulate 42 is impacted on the filter media 62 (step 408). Once in the bypass position 40, a filter change indicator is activated (step 410).

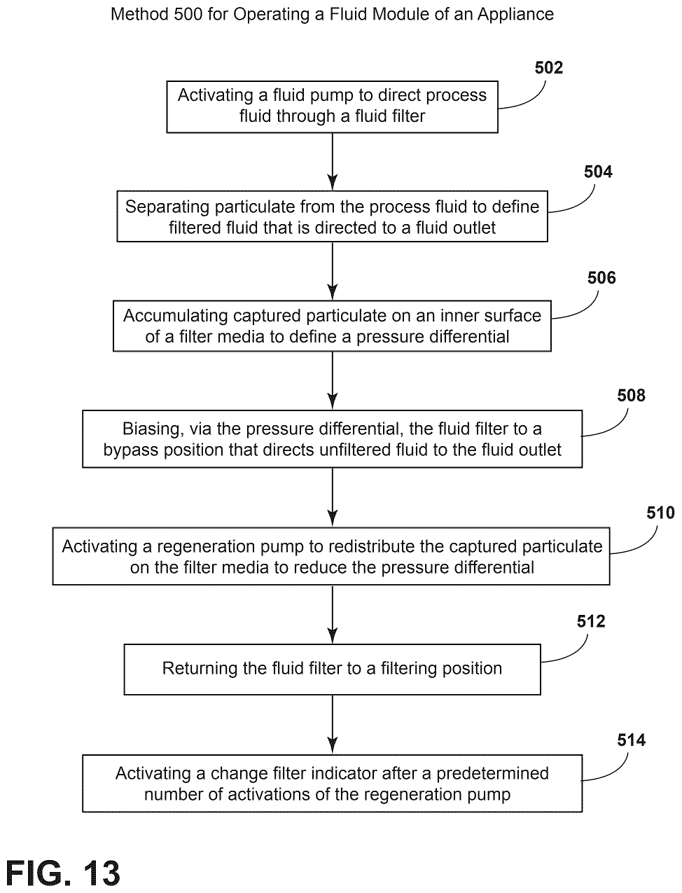

Referring now to FIGS. 1-11 and 13, having described the various aspects of the device, a method 500 is disclosed for operating a filter module 10. According to the method 500, a step 502 includes activating the fluid pump 38 to direct the process fluid 16 through the fluid filter 28 in the filtering position 36. Particulate 14 is then separated from a process fluid 16 to define filtered fluid 150 that is directed to the fluid outlet 26 (step 504). Captured particulate 42 is accumulated on the inner surface of the filter media 62 of the fluid filter 28 (step 506). The fluid filter 28 is biased to the bypass position 40 when an amount of the captured particulate 42 is accumulated on the filter media 62 (step 508). When the fluid filter 28 is moved to the bypass position 40, a regeneration pump 220 is activated to redistribute the captured particulate 42 on the filter media 62 to clear portions of the filter media 62 (step 510). By clearing portions of the filter media 62, the fluid filter 28 is returned to the filtering position 36 (step 512). A change filter indicator is activated when operation of the regeneration pump 220 returns the filter to the filtering position 36 for a predetermined period of time before the fluid filter 28 is returned to the bypass position 40 by the accumulation of captured particulate 42 on the filter media 62 (step 514).

According to the various aspects of the device, the filter module 10 operates to separate fine particulate 14, typically in the form of microfibers and other micro-particles, from process fluid 16 moving through the appliance 12. By removing these microparticles, they can be captured within the fluid filter 28 and prevented from being reintroduced into a particular water supply. Use of the filter module 10 through various appliances can operate to capture large amounts of these microparticles to limit the presence of these microparticles within municipal water supplies, reservoirs, wells, and other sources of water. By capturing these microparticles, they can be recycled or disposed of at a central location. Use of the fluid module described herein creates a two-stage filtering process that filters larger particulate 14 and objects within an upstream filter 90 and also filters the microparticles within the filter media 62 defined within the particulate collector 32. This particulate collector 32 or the filter media 62 can be removed from the filter module 10 and cleaned or replaced as needed in a convenient manner.

The invention disclosed herein is further summarized in the following paragraphs and is further characterized by combinations of any and all of the various aspects described therein.

According to another aspect of the present disclosure, an appliance including a fluid delivery system having a filter housing that defines a filter chamber disposed between a fluid inlet and a fluid outlet, a fluid filter selectively disposed within the filter chamber, the fluid filter having a base and a particulate collector attached to the base via a biasing mechanism that biases the particulate collector toward a filtering position, and a fluid pump that directs fluid through the filter chamber via the fluid inlet, wherein operation of the fluid pump in the filtering position of the particulate collector directs the fluid from the fluid inlet and through a filter media of the particulate collector that biases the particulate collector away from the filtering position, wherein the filter media separates particulate matter from the fluid to define captured particulate within the filter media, and wherein when the filter media is impacted by an amount of the captured particulate, movement of the fluid through the particulate collector creates a pressure differential that overcomes the biasing mechanism and biases the particulate collector to a bypass position that directs at least a portion of the fluid around an outside surface of the particulate collector and to the fluid outlet.

According to another aspect of the present disclosure, the particulate collector has a seat at a first end of the particulate collector, wherein the seat engages the fluid inlet in the filtering position and directs the fluid through the filter media.

According to another aspect of the present disclosure, the seat includes a seal that seals the particulate collector around the fluid inlet in the filtering position.

According to another aspect of the present disclosure, the biasing mechanism is disposed at a second end of the particulate collector, wherein the second end is opposite the first end.

According to another aspect of the present disclosure, the filter housing includes a volute that is upstream from the fluid inlet, and wherein the filter chamber and the volute are separated by an interior wall, wherein the fluid inlet is defined within the interior wall.

According to another aspect of the present disclosure, the filter chamber and the volute are connected by a flow channel that is defined by the interior wall and an outer wall of the housing.

According to another aspect of the present disclosure, a regeneration mechanism that selectively operates to redistribute the captured particulate within the particulate collector and to reaccumulate on at least one concentrated portion of the filter media, wherein cleaned portions of the filter media are defined between the at least one concentrated portion of the filter media.

According to another aspect of the present disclosure, the regeneration mechanism is a regeneration pump that directs an opposing flow of a regeneration fluid from an area outside the filter media and into an inside of the particulate collector via the filter media.

According to another aspect of the present disclosure, a filter module for an appliance includes a filter housing defining a filter chamber, a fluid pump incorporated with the filter housing and configured to direct a fluid toward a fluid outlet of the filter housing, a fluid filter selectively disposed within the filter chamber and having a base and a particulate collector, wherein the particulate collector separates particulate matter from the fluid to define captured particulate within a filter media of the particulate collector, and a bypass mechanism that is operable between a filtering position and a bypass position, wherein the bypass mechanism is continuously biased toward the filtering position that directs the fluid through a filter media of the particulate collector and to the fluid outlet to define a filtered fluid, and wherein the bypass mechanism is selectively biased to the bypass position when the filter media is impacted by an amount of the captured particulate, wherein the bypass position is characterized by the fluid pump directing at least a portion of the fluid through a bypass path that extends around the particulate collector to the fluid outlet to define an unfiltered fluid.

According to another aspect of the present disclosure, the bypass mechanism is progressively operable from the filtering position to the bypass position as the filter media progressively collects the captured particulate.

According to another aspect of the present disclosure, the bypass mechanism is a bypass valve that moves from the filtering position toward the bypass position as the filter media progressively collects the captured particulate.

According to another aspect of the present disclosure, the bypass mechanism is a biasing mechanism that extends between the base and the particulate collector.

According to another aspect of the present disclosure, a seat of the particulate collector engages a fluid inlet of the filter chamber in the filtering position, and wherein the bypass position is characterized by the seat moving away from the fluid inlet to define the bypass path from the fluid inlet and along an outer surface of the particulate chamber to the fluid outlet.

According to another aspect of the present disclosure, the fluid pump includes an impeller that operates within a volute of the housing, and wherein the bypass valve is disposed within a wall of the volute.

According to another aspect of the present disclosure, the bypass path is separated from the filter chamber and extends from the bypass valve of the volute to the fluid outlet.

According to another aspect of the present disclosure, a regeneration mechanism that selectively operates to redistribute the captured particulate within the particulate collector and to reaccumulate on at least one concentrated portion of the filter media, thereby cleaning at least a portion of the inner surface of the filter media that is defined around the at least one concentrated portion.

According to another aspect of the present disclosure, the regeneration mechanism is a regeneration pump that directs an opposing flow of a regeneration fluid from an area outside the filter media and into an inside of the particulate collector via the filter media.

According to another aspect of the present disclosure, a filter module for an appliance includes a filter housing having an impeller chamber and a filter chamber that are connected by a fluid inlet, a fluid filter within the filter chamber that separates particulate matter from a fluid to define captured particulate, the fluid filter operable between a filtering position and a bypass position, a biasing mechanism that biases the fluid filter toward the filtering position, and a fluid pump that directs the fluid from the impeller chamber and through the fluid filter in the filtering position and defines a pressure differential that biases the fluid filter toward the bypass position, wherein when an accumulation of the captured particulate is defined on an inner surface of the fluid filter, the pressure differential overcomes the biasing mechanism and operates the fluid filter to the bypass position that directs at least a portion of the fluid through a bypass path that extend from the fluid inlet, around an outer surface of the fluid filter, and to an outlet of the fluid housing.

According to another aspect of the present disclosure, a regeneration pump that selectively delivers an opposing flow of regeneration fluid through the fluid filter and through the inner surface to redistribute the captured particulate within the fluid filter to accumulate on a concentrated portion of the inner surface of the fluid filter, thereby cleaning at least a portion of the inner surface and decreasing the fluid pressure, wherein the biasing mechanism moves the fluid filter toward the filtering position.

According to another aspect of the present disclosure, the fluid filter includes a seat that engages the fluid inlet in the filtering position, and wherein the seat separates from the fluid inlet in the bypass position.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An appliance comprising:
a fluid delivery system having a filter housing that defines a filter chamber disposed between a fluid inlet and a fluid outlet;
a fluid filter selectively disposed within the filter chamber, the fluid filter having a base and a particulate collector attached to the base via a biasing mechanism that biases the particulate collector toward a filtering position; and
a fluid pump that directs fluid through the filter chamber via the fluid inlet, wherein operation of the fluid pump in the filtering position of the particulate collector directs the fluid from the fluid inlet and through a filter media of the particulate collector that biases the particulate collector away from the filtering position, wherein the filter media separates particulate matter from the fluid to define captured particulate within the filter media, and wherein when the filter media is impacted by an amount of the captured particulate, movement of the fluid through the particulate collector creates a pressure differential that overcomes the biasing mechanism and biases the particulate collector to a bypass position that directs at least a portion of the fluid around an outside surface of the particulate collector and to the fluid outlet.

2. The appliance of claim 1, wherein the particulate collector has a seat at a first end of the particulate collector, wherein the seat engages the fluid inlet in the filtering position and directs the fluid through the filter media.

3. The appliance of claim 2, wherein the seat includes a seal that seals the particulate collector around the fluid inlet in the filtering position.

4. The appliance of claim 2, wherein the biasing mechanism is disposed at a second end of the particulate collector, wherein the second end is opposite the first end.

5. The appliance of claim 1, wherein the filter housing includes a volute that is upstream from the fluid inlet, and wherein the filter chamber and the volute are separated by an interior wall, wherein the fluid inlet is defined within the interior wall.

6. The appliance of claim 5, wherein the filter chamber and the volute are connected by a flow channel that is defined by the interior wall and an outer wall of the filter housing.

7. The appliance of claim 1, further comprising a regeneration mechanism that selectively operates to redistribute the captured particulate within the particulate collector and to reaccumulate on at least one concentrated portion of the filter media, wherein cleaned portions of the filter media are defined between the at least one concentrated portion of the filter media.

8. The appliance of claim 7, wherein the regeneration mechanism is a regeneration pump that directs an opposing flow of a regeneration fluid from an area outside the filter media and into an inside of the particulate collector via the filter media.

9. A filter module for an appliance comprising:
a filter housing defining a filter chamber;
a fluid pump incorporated with the filter housing and configured to direct a fluid toward a fluid outlet of the filter housing;
a fluid filter selectively disposed within the filter chamber and having a base and a particulate collector, wherein the particulate collector separates particulate matter from the fluid to define captured particulate within a filter media of the particulate collector; and
a bypass mechanism that is operable between a filtering position and a bypass position, wherein the bypass mechanism is continuously biased toward the filtering position that directs the fluid through a filter media of the particulate collector and to the fluid outlet to define a filtered fluid, and wherein the bypass mechanism is selectively biased to the bypass position when the filter media is impacted by an amount of the captured particulate, wherein the bypass position is characterized by the fluid pump directing at least a portion of the fluid through a bypass path that extends around the particulate collector to the fluid outlet to define an unfiltered fluid.

10. The filter module of claim 9, wherein the bypass mechanism is progressively operable from the filtering position to the bypass position as the filter media progressively collects the captured particulate.

11. The filter module of claim 10, wherein the bypass mechanism is a bypass valve that moves from the filtering position toward the bypass position as the filter media progressively collects the captured particulate.

12. The filter module of claim 9, wherein the bypass mechanism is a biasing mechanism that extends between the base and the particulate collector.

13. The filter module of claim 12, wherein a seat of the particulate collector engages a fluid inlet of the filter chamber in the filtering position, and wherein the bypass position is characterized by the seat moving away from the fluid inlet to define the bypass path from the fluid inlet and along an outer surface of the particulate collector to the fluid outlet.

14. The filter module of claim 11, wherein the fluid pump includes an impeller that operates within a volute of the filter housing, and wherein the bypass valve is disposed within a wall of the volute.

15. The filter module of claim 14, wherein the bypass path is separated from the filter chamber and extends from the bypass valve of the volute to the fluid outlet.

16. The filter module of claim 9, further comprising a regeneration mechanism that selectively operates to redistribute the captured particulate within the particulate collector and to reaccumulate on at least one concentrated portion of the filter media, thereby cleaning at least a portion of an inner surface of the filter media that is defined around the at least one concentrated portion.

17. The filter module of claim 16, wherein the regeneration mechanism is a regeneration pump that directs an opposing flow of a regeneration fluid from an area outside the filter media and into an inside of the particulate collector via the filter media.

18. A filter module for an appliance comprising:
a filter housing having an impeller chamber and a filter chamber that are connected by a fluid inlet;
a fluid filter within the filter chamber that separates particulate matter from a fluid to define captured particulate, the fluid filter operable between a filtering position and a bypass position;
a biasing mechanism that biases the fluid filter toward the filtering position; and
a fluid pump that directs the fluid from the impeller chamber and through the fluid filter in the filtering position and defines a pressure differential that biases the fluid filter toward the bypass position, wherein when an accumulation of the captured particulate is defined on an inner surface of the fluid filter, the pressure differential overcomes the biasing mechanism and operates the fluid filter to the bypass position that directs at least a portion of the fluid through a bypass path that extend from the fluid inlet, around an outer surface of the fluid filter, and to an outlet of the filter housing.

19. The filter module of claim 18, further comprising a regeneration pump that selectively delivers an opposing flow of regeneration fluid through the fluid filter and through the inner surface to redistribute the captured particulate within the fluid filter to accumulate on a concentrated portion of the inner surface of the fluid filter, thereby cleaning at least a portion of the inner surface and decreasing the fluid pressure, wherein the biasing mechanism moves the fluid filter toward the filtering position.

20. The filter module of claim 18, wherein the fluid filter includes a seat that engages the fluid inlet in the filtering position, and wherein the seat separates from the fluid inlet in the bypass position.
